(19) United States
(12) Patent Application Publication
(10) Pub. No.: US 2002/0055089 A1
(43) Pub. Date: May 9, 2002

(54) Method and system for delivering homework management solutions to a designated market

(75) Inventor: Lois R. Scheirer, Lexington, MA (US)

Correspondence Address: e-Vantage International, Inc., 230 Waltham Street, Lexington, MA, 02421, US

(73) Assignee: e-Vantage International, Inc.

(21) Appl. No.: 09/981,418

(22) Filed: Oct. 18, 2001

Related U.S. Application Data
(60) Provisional application No. 60/238,270, filed on Oct. 5, 2000.

(51) Int. Cl. G09B 7/00; G09B 3/00

(52) U.S. Cl. 434/350; 434/323; 434/362

(57) ABSTRACT

Consistent with principles of the present invention, a method and system for delivering homework management solutions to a designated market is disclosed. For each user, the disclosed system generates a user-profile that is consistent with, for teenage student-user's learning disabilities and required learning modifications or accommodations in response to user information and external regulatory requirements, and for teacher-users with, authorities. The disclosed system may further operate to determine appropriate intervention strategies and associated resource tools for a user, consistent with regulatory requirements, and process a request for an intervention tool or strategy from the user. Various interventions and modifications may be obtained and/or utilized through the disclosed system, relative to homework assignments for tests and related output, reading and related output, as well as projects and related output. Resources required for utilizing these various interventions may also be obtained and/or utilized through the disclosed system. The disclosed system also provides training, motivating, compliance and reporting features. By utilizing the disclosed system, the designated market is provided with methods and systems to help bypass, work around, and/or compensate for specific learning difficulties.

### CROSS REFERENCE TO RELATED APPLICATIONS

This application claims priority under 35 U.S.C. §119(e) to provisional patent application Ser. No. 60/238,270 filed Oct. 5, 2000.

### BACKGROUND OF THE INVENTION

This present invention generally relates to providing an end-to-end personalized homework management service to a target educational market capable of educating, predicting needs, analyzing alternative solutions, matching service solutions to need, initiating solutions, and reporting and communicating the outcomes. In particular, the present invention relates to an Internet based application designed to provide these functions.

The World Wide Web (“WWW” or “Internet”) has rendered the Internet and other interactive online computer networks accessible to educators and students everywhere. Concomitant with the emergence of this new communication medium, the opportunity for educators to provide online interactive services including computer assisted instruction (such as drills, quizzes, and practices), computer supported activities (such as tutoring, audio books), computer managed instruction (such as scheduling and grading), and computer assisted learning environments (such as manipulation) has motivated the development of new technologies. The demand for such online systems is estimated to be growing at a rapid rate, and such systems may be especially useful to learning disabled and otherwise disadvantaged students and their teachers.

In the United States, learning problems affect an estimated 15% of all school age children. Of these, about 6 million students have significant enough problems to receive special education services according to the National Center for Education Statistics (NCES). Enrollments in special education programs have risen steadily both in absolute numbers and as a percentage of the total student population over the past ten years. So it is not surprising that the number of students with disabilities that are educated in the regular classroom increased nearly 20% from 19985 to 1995 according to NCES. In the 1995-96 year, 45% of students with disabilities were educated in the regular classroom, up from 25% in 1965-86. At the same time, Resource Room usage dropped to 29% from 43% indicating less personal attention.

Despite these service trends, today the cost of special education is estimated by the Education Finance Statistics Center to range from $30 billion to $34.8 billion. With more and more students requiring interventions for learning problems, the associated delivery costs are rising. Evidence suggests that rising special education costs are creating resource competition with general education and are increasingly considered unsustainable. Task forces in states such as California and Vermont are claiming that costs are unsustainable and are putting entire systems at risk. Clearly, learning problems create a management intense and costly learning situation.

Of the children with access to special education services, almost half (46.o%) received services for specific Learning Disabilities (LD). Learning Disabilities are defined as by the Office of Special Education as a “disorder in one or more of the basic psychological processes involved in understanding or in using language, spoken or written, which manifests itself in imperfect ability to listen, think, speak, read, write, spell or do mathematical calculations.” Names of disorders that are commonly associated with LD include: 1) dyslexia (difficulty with language processing that impacts reading, writing, and spelling), 2) dyspraxia (difficulty with motor planning), 3) dysgraphia (difficulty with writing, spelling and formulation of written composition), 4) auditory discrimination (difficulty with the efficient use of language because of the inability to perceive the differences between speech sounds), and 5) visual perception (difficulty with noticing important details and assigning meaning to what is seen.) Attention Deficit Disorder with or without hyperactivity often occurs with LD, but it is considered distinct.

As student progress toward high school, the evidences of LD evolve and are evidenced by problems around: 1) learning foreign languages, summarizing materials, or understanding explanations; 2) retention of memory including trouble with cumulative learning; 3) attention including mental fatigue; and 4) fine motor skills including physical problems writing. The National Center for Learning Disabilities identifies “guideposts” of the typical expressions of LD and include the following: problems managing time, completing assignments, organizing thoughts, locating belongings, carrying out plans, setting priorities, making decisions, and sequencing activities. In high school, LD students are expected to carry out multiple assignments and projects both in school and out that require higher level conceptual skills, heavy reading, and extensive writing. These demands tend to results in LD student exhibiting inconsistent performance—often showing inherent ability, but then, unable to store, process or produce information at the level of their other capabilities, their performance suffers and they become at risk for failure and low self esteem.

With the passage by Congress of the Individuals with Disabilities Education Act (IEDA) in 1997, services classified as Assistive Technology (AT) became mandated as part of a “freed appropriate public education”. IDEA forces the participation of disabled students in general education curriculum and consequently AT is an important enabler of that goal. AT is generally classified as a class of educational “scaffold”, which is any method of support which helps students make a transition from their current knowledge base and skills to their next levels of learning. Scaffolds, when applied to LD, may include any tool or technique that anticipates difficulties with a set of activities and provides a structure around that activity that supports success.

In response to the growing LD population, the increasing demands for higher academic performance, and the cost of special education delivery, there is an urgent need for a technology based, efficient, and personalized homework delivery solution directed specifically to meet LD challenges surrounding homework management. Such solutions need to incorporate key principles of educational theory and comply with AT standards. They need to enable both students and teachers by facilitating learning, communication, collaboration as well as offering specialized resources.

Such a solution would advantageously support homework delivery, enabling teenage students and teachers alike. It would remove organizational barriers and provide resources to students when and where they need them. It would develop organization and time management skills. It would deliver to teachers and special education staff new efficiency and effectiveness, and at the same time, assure compliance with policies and programs as mandated under IDEA. Finally, such a delivery could be utilized by learning disadvantaged students, creating supports for success in the absence of such supports due to environment or cultural factors rather than medical factors.

### BRIEF SUMMARY OF THE INVENTION

Consistent with principles of the present invention, a method and system for delivering organization and homework production management solutions to a designated market is disclosed. For each student-user, a teenager, the disclosed system provides personalized real-time tracking and coaching throughout the course of each day for the schedule of classes, activities, and homework assignments, including assignments pending predicted in order of priority, and makes accessible specifically designed learning resources. Around this core scheduling and time management function are three primary applications that provide organizational support and personalized learning interventions. These are: 1) test preparation and taking, 2) reading and associated report production, and 3) project management. In each of these three applications, this solution tracks and prioritizes assigned and past due homework delivery requirements along a timeline with collaboratively set milestones. It allocates specialized production resources consistent with a user profile and creates a venue for communication, reporting and rewarding on-going performance against standards. Warnings of missed milestones are provided and strategies for getting back on track along the collaboratively set adjustments are projected and recommended. The system recognizes and measures success and failure. It rewards success and provides support and redirection for failures. Functions are integrated, so that daily work assignments and work production achievements are communicated throughout all relevant functions. Privacy and security are achieved for both student and teacher-users through a compliance function.

For example, under a given set of circumstances applicable to a particular student user, the disclosed system operates to generate under password authentication a personalized daily schedule of all activities sorted by time period for the day or by other variables in addition to time periods such as by course. The system also highlights the current class period and provides notice of key assignments needing attention in order of priority for that class.

As a further service, the disclosed system may operate to generate for a student user a personalized assignment record by calendar date/day on a daily, weekly or monthly basis and by course or based on other factors, utilizing templates that predict and implement modifications and interventions consistent with the student's Individual Educational Plan (IEP) or other referenced source. The system may further include in this assignment record, assignments relative to reading, writing, problems to solve, or other types of output adjusted for required modifications as projected by the user profile, as well as resources to access in performing these assigned tasks and their associated due dates using formats consistent with LD requirements. The system then provides communication alternative for delivery of assignments which may include utilizing specifically designed templates by LD type, for example, or e-mails or on-line tutoring. Finally, the system identifies and provides rewards on a personalized basis for success and tracks performance according to multiple criteria under compliance standards for privacy and security.

A student user of the disclosed system might further use this system to prepare for test scheduling, test taking, and test correcting for each course. In this regard, the system provides a personalized specifically designed test schedule for LD that is collaboratively developed with the teachers/tutor/administrator and assigns incremental milestones to a timeline for achievement. It then tracks and reports success and failure. A reward structure recognizes success. Further, a student user can access communication capabilities directly with a teacher/tutor, reporting when assignments are completed, or when resources are needed to achieve success, or delivering test assignments electronically. Interventions including practice tests, access to problem solutions drawn from a library of testing solutions relate to each disorder in such a way that the system educates, predicts, selects, simplifies, communicates, and reports the most effective test management strategies for each student user based on their student profile.

In an illustrative embodiment, the disclosed system provides a Web-site based application including a number of associated software processes. Such software processes may operate to support longer-term reading assignments and project management. The student user, when approaching daily reading and accompanying report writing assignments, uses this disclosed system to manage the process utilizing a calendar record of assigned readings that are chucked, with past due readings integrated into the work load schedule consistent with prescribed modification. Access to resources such as audio tapes or outlines or texts with “yellow” highlighting inserted are provided on line consistent with the users IEP or other reference. Interactive step-by step templates create the consistent structure for report writing by subject and activity type which integrate modifications and formats appropriate for the student by profile. The template format remains consistent across subjects and grade levels, with incremental complexities added as students progress.

The server based processes of the disclosed system further may operate to create a personalized interactive step-by-step approach to project management by the student-user that educates, predicts, simplifies, selects, communicates, and controls user specific project management on a personalized basis. Utilizing resources such as tailored templates designed by, for example, course, grade level, and disability or other category, together with designated modifications, students obtain access to resources that may be employed in achieving project management success. Projects are chunked along timelines with milestones collaborative established that are then tracked and reported. Success is rewarded and failure is monitored to assure the appropriateness of the IEP or other reference document.

Supporting each student-user is a teacher/tutor/special education professional user, here designated at the “teacher-user”. For the teacher-user, the disclosed system educates, predicts and selects appropriate modifications and interventions, simplifies communication, and tracks, reports and measures student performance and achievement in a confidential, secure and personal manner.

The teacher-user initially enters the system through an access security process in order to efficiently and effectively at set up each student's Profile created through a predetermined set of interactive questions. Guidance for the Profile selections comes from each student's Individualized Educational Plan or other reference source that determines each student's learning needs. To facilitate this process, this system provides standard IEP format templates consistent with government regulations. Further, the system presents teacher-users with resources that educate and provide access to expert solutions. Such resources may include checklists of effective modifications and interventions by LD type, profiles of specific learning disabilities prepared by experts, recommended teaching strategies, training relative to categories of LD, or access to a centered community of teachers and educational experts.

Teacher-users may establish each student's Profile through an interactive step-by-step process at the beginning of the academic year with changes made as needed. Then, on an on-going daily basis, teachers interact with students utilizing such capabilities as pre-formatted templates provided by subject, level and disability, for example, that predict and assign the modifications or interventions designed in the Profile by student for all homework assignments. For example, if a student Profile calls for reduced computation of math problems to accommodate a fine motor skill problem, the teacher-user, in establishing the Student Profile may select from among alternatives, a reduction of a certain percentage of problems. For further example, if a teacher-user assigns a 50% reduction, the system may present alternatives formulas such as completion of every other problem or the first half of all problems. The system takes pre-established modification formulas established in the Profile, and adapts the teacher's standard homework assigned accordingly. As a result, the teacher-user simply enters the standard assignment, or the standard assignment is pulled into this system from an external file, and the appropriate modification is applied to each student's work consistent with the Profile. This serves to reduce teacher-user administrative time and enhances compliance with pre-determined educational modifications and interventions.

A further service offered by the disclosed system to a teacher-user involves daily communication with the student and monitoring of each student's progress and performance through a Student Relationship Management (SRM) application. This system insures compliance with Individual Education Plans as well as with standards and policies of school districts, state laws, and national requirements. This feature serves to develop a collaborative work process with student-users.

The disclosed system additionally includes processes and tools for educating and training both students and teachers regarding learning problems associated with learning disabilities or created by others sources of learning disadvantage. Another aspect of the disclosed system includes a process for measuring, tracking, reporting and analyzing results on an individual, department, school, region and state level, thus creating a cost effective research tool while protecting individual student and teacher-user confidentiality and privacy.

The advantages of the disclosed system are many. In particular, the disclosed system integrates end-to-end personalized services that produce time and cost savings with all services at one Web site location. Further, it automates functions currently not automated. It creates a structured community among various user-groups with access to experts. It educates as well as simplifies the homework management process while making it more effective. It meets standards set by the Individuals with Disabilities Education Act (IDEA) and complies with accessible software design standards set by the U.S. Department of Education, Office of the Chief Information Officer using Universal Design principals. These include standards for keyboard access, icons, objects and controls, sounds, displays, field labeling and documentation. It meets the criteria set by experts in Special Education relative to established criteria for effective AT. With its approach, the disclosed system predicts user needs and delivers the solution in a concise directed manner that addresses common errors in applying techniques and methods to educational interventions within the intended marketplace.

For school administrations in particular, the disclosed system enables cost-effective delivery of new dimensions of service that are compliant with government standards and compliment existing technology. In this regards, the disclosed system may be employed by a school system to better educate the targeted student population, increase teacher productivity, structure compliance, and gain new methods to measure effectiveness and gage success while maintaining student-user and teacher-user privacy.

For teacher-users, in particular, the system enhances effectiveness by providing access to expertise in one location where and when they need it, creates new methods for timely but private implementation of student modifications, and provides new avenues for collaboration with students. It assures that teachers are in compliance with the school's policies and practices and with the students mandated intervention program. Through the system's computer aided instruction, new personalized expert methods of can be employed. Through computer aided management, teacher-user gain new efficiency in implementing personalized programs, tracking student's successes and failures, and advocating adjustments to programs. In the end, the disclosed system will change the way schools educate and relate to LD students.

For students, the disclosed system's benefits are most significant. First, it empowers them for success in homework by removing organization barriers and delivering personalized resources where and when students need them. It delivers modifications is a secure and private way. It automates a process that today is time consuming and often ineffective. Through its automated processes, students learn to develop new levels of organization and time management skills. Through the regular use of methodologies such as the interactive templates, students progress in skills associated with organizing thoughts, carrying out plans, setting priorities, making decisions, and sequencing complex situations. As a result, students can handle higher academic loads as well as experience greater and consistent success. Through new collaborative capabilities, students interact with teachers, tutors, and parents in empowering ways. And utilizing expert resources provided, students gain self-advocacy skills through enhanced self understanding that will take them into adulthood.

### BRIEF DESCRIPTION OF THE SEVERAL VIEWS OF THE DRAWING

The invention will be more fully understood by reference to the following detailed description of the invention in conjunction with the drawings, of which:

FIG. 1 illustrates a client-server computer network including hardware and software components through which the disclosed system may be embodied;

FIG. 2 illustrates a flowchart diagram of the disclosed process for providing end-to-end real time homework management solutions to a target market and the automated services that support delivery of that process;

FIG. 3 illustrates, through the elemental components of an illustrative best practices survey, an exemplary methodology embodied in the disclosed system for utilizing technology to provide knowledge which supports changed behavior and results in enhanced learning, for building community, and for creating proprietary content;

FIG. 4 illustrates a diagrammatic representation of an embodiment of the disclosed system for creating and summarizing the teacher-and student-user profiles in increasing detail through a profile map that is created simultaneously to an authorized user completing the profiles (or input file is uploaded for the IEP format) which is then displayed representing the users full profile and utilized to populate and personalize the site features;

FIG. 5 illustrates the disclosed process for quickly and effectively focus, track, modify, and structure a schedule 62 relative to managing independent activities 64 and responsibilities under projected priorities for assignments 66 through user specific data;

FIG. 6 illustrates display objects of the disclosed system presenting calendar based schedules by period, course, daily, or week, for example, in a minimalist and personalized format in real-time that creates focused perspective at any point in time relative to, for example, class periods, teachers, room assignments, book assignments, or current schedules;

FIG. 7 illustrates a plurality of inter-operating software components that may be used to effectively focus, organize, train, empower, track, reward, manage and communicate with regard to homework assignments and their completion, designed for the target market's education characteristics, that create a real-time interactive user experience under applicable compliance standards;

FIG. 8 illustrates the output displays of the assignment record offerings of the disclosed system;

FIG. 9 illustrates a plurality of inter-operating software libraries of the disclosed system that may be selected, matched and integrated into to particular student-user profiles and service deliveries with regard to designated learning problems relative to homework assignment organization and completion, designed for the target market's education characteristics, that create a real-time interactive user experience under applicable compliance standards;

FIG. 10 illustrates the display output of an interactive template which represents an exemplary method of the present invention of support and structure for developing, organizing, and applying interventions consistent with learning disability types;

FIG. 11 illustrates a plurality of inter-operating software components that may be used to effectively develop organizational and time management skills relative to testing, reading, and project assignments. Further, these may be utilized for communication among and between users relative to task completion or problems, designed for the target market's education characteristics, that create a real-time interactive user experience under applicable compliance standards;

FIG. 12 illustrates the functionality of a student-user set of personalized screens of the disclosed system which may be utilized for organization, production and time management relative to the target market's learning characteristics for projects and related output; for readings and related output; for testing and related output; or for computing and related output, or other academic functions;

FIG. 13 illustrates the disclosed systems compliance process for management of security and privacy as well as for compliance with governance of policies and procedures of school districts, and laws and regulations of state and federal governments relative to the target market's educational opportunities;

FIG. 14 illustrates exemplary student relationship management functions that may be embodied in the disclosed system, and that are designed to foster and develop organizational and time management skills, predict and apply interventions and modifications relative to the target market's educational characteristics, to foster communication within the centered community, build teacher and student-user loyalty, efficiently measure student and teacher and school activities; and relate automated capabilities to users.

FIG. 15 illustrates an exemplary embodiment of the disclosed system in using an integrated process flow between the various users;

FIG. 16 illustrates a features that may be accessed by a plurality of student-(parent) users or teacher (resource room/administration)-users that are communicably coupled to a server system in order to expertly select, apply, and report on the full range of end-to-end academic work management solutions through a knowledge engine component, decision support technology component, and an assignment interface component.

### DETAILED DESCRIPTION OF THE INVENTION

The disclosure of provisional patent application Ser. No. 60/236,270 filed Oct. 5, 2000, is hereby incorporated by reference herein.

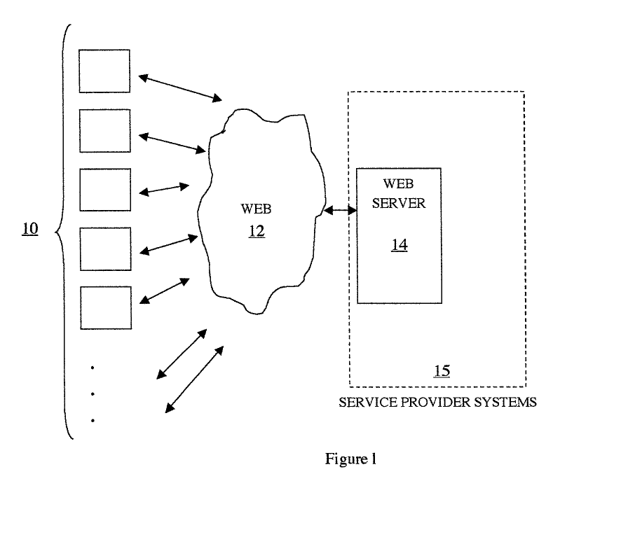

As shown in FIG. 1, a plurality of client systems 10 are communicably coupled via the World Wide Web (“Web”) 12 to a server system 14. The server system 14 is, for example, one or more computer systems operating within a number of service provider systems 15. During operation of the elements shown in FIG. 1, users of the client systems 10 employ client software, such as a browser computer program, to communicate with a Web site provided by Web server software executing on the server system 14.

For example, as shown in FIG. 1, client systems 10 effect transactions to the server system 14 using the Hypertext Transfer Protocol (HTTP), which is a known application protocol providing users access to various types of files (e.g. text, graphics, images, sound, video, etc.) using a standard page description language known as the Hypertext Markup Language (HTML). A Web page is a document that is accessible over the Web, and that is typically identified using a Uniform Resource Locator (URL). Accordingly, requests for Web pages through an HTML-compatible browser (e.g. Netscape Navigator or Microsoft Internet Explorer) executing on one of the client systems 10 generally involve specification of a requested Web page by that Web page's URL. The requesting one of the client systems 10 receives, in return, a document or other object formatted according to HTML. A collection of Web pages and/or other documents or programs supported on a Web server or servers, such as the Web server 14, is sometimes referred to as a Web site.

In a preferred embodiment, the server system 14 includes a Web site and an associated information database. Thus the server system 14 provides a Web-based application program accessible by the client systems 10 over the World Wide Web 12. As it is generally known, the client systems 10 typically include a suite of conventional Internet tools, including a Web browser, operable to access and obtain services from servers connected to the Web 12. Various known Internet protocols are used in connection with the services provided by servers within the Web server system 14. Thus, for example, browsing may be provided using the Hypertext Transfer Protocol (HTTP), which provides users of the client systems 10 access to multimedia files, including files written in the Hypertext Markup Language (HTML).

For purposes of illustration, a representative one of the client systems 10 may be a personal computer, notebook computer, Internet appliance or personal computing device (e.g. a PDA), that may, for example, be based on one or more x86-, PowerPC®, or RISC type processors. An illustrative client system may include an operating system such as Microsoft Windows or Microsoft Windows CE. As noted above, each client system may include a suite of Internet tools including a Web browser, such as Netscape Navigator or Microsoft Internet Explorer, that may have a Java Virtual Machine (JVM) and/or support for application plug-ins or helper applications.

Further for purposes of illustration, a representative Web server system 14 is based on an Intel i686 central processing unit (CPU), and includes an associated memory for storing programs executable on the CPU. The Web server system 14 further runs an appropriate operating system, such as the Linux operating system and the Apache Web server program. Various communication links may be used to connect to the Web server system 14, such as a Digital Subscriber line or T1 connection. In the illustrative embodiment in which the disclosed system is embodied as software executing in connection with a Web site, the following description and associated figures describe operation of the software associated with and accessed through such a Web site.

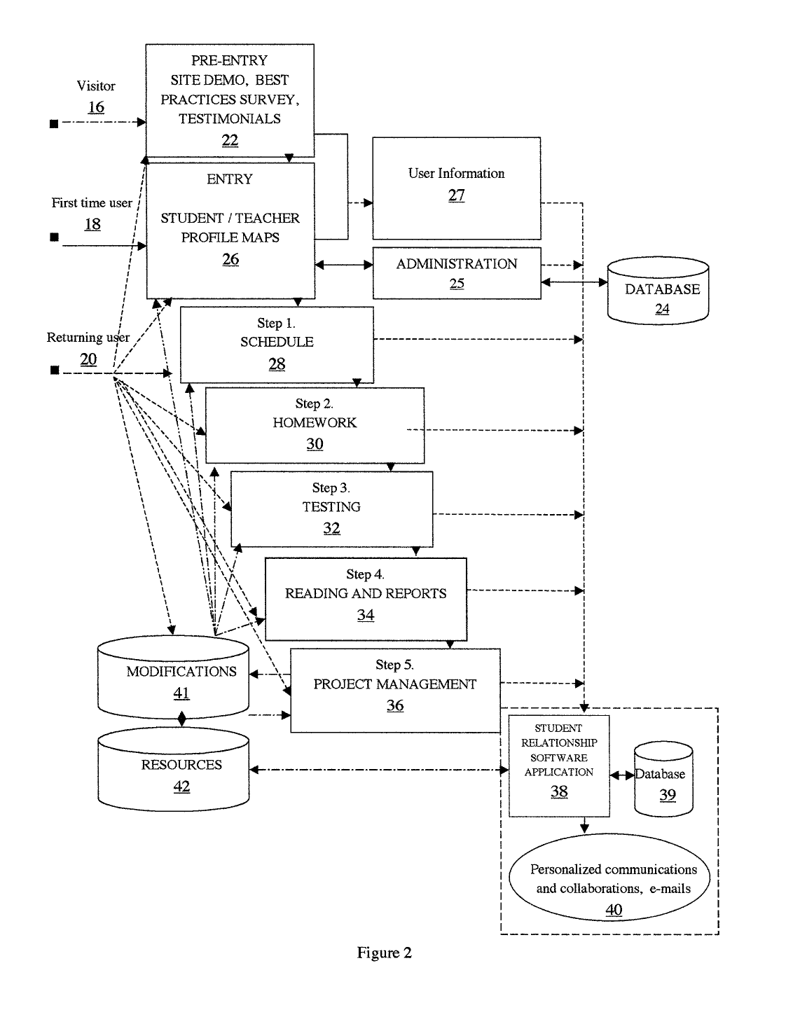

As shown in FIG. 2, a visitor 16 to the disclosed Web site is provided at step 22 with a sales functionality for the system, shown for purposes of illustration as an online, site demonstration or on-line best practices survey. The survey provided by the software component 22 may, for example, consist of a series of screens or Web pages including categorized inquiries. Best practices may refer to preferred methods, operations processes and/or controls for achieving consistent and desired learning results.

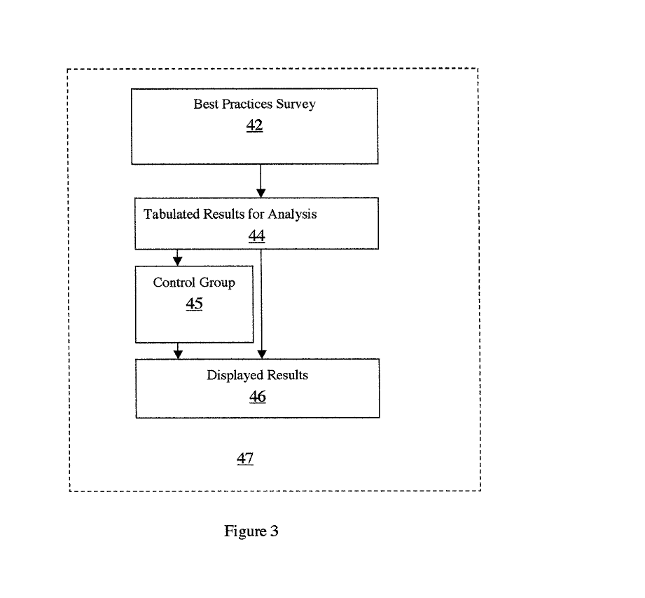

FIG. 3 shows an example of a steps that perform the best practices survey provided by the software component 22 in FIG. 2. As shown in FIG. 3, an initial step of obtaining customer specific background data through an on-lie best practices survey is performed at step 42. The customer specific background data at step 42 may include company or individual registrant specific information, answers to questions directly related to visitor specific learning interventions such as methods for support and structure, and/or computer management strategies employed, in addition to implementation questions governing such functions as online tutoring, testing, or viewing.

Next, at step 44, the disclosed system tabulates results from the survey provided at step 42. The tabulation performed at step 44 organized the survey results so that the information is categorized with respect to various methods of special education management, and compared to baseline information. The baseline information may include or exclude the information the information received from any given user. The baseline information may be selected from in or outside of the registrant based on predetermined answers to select questions indicative of preferred special education management practices. For example, if a given user provides an answer to one of the questions provided during the best practices survey that matches a predetermined “best” answer to that particular question, then the disclosed system may operate to store one or more answers to together questions received from that given user as “baseline” information at step 45.

At step 46, the disclosed system displays the results of the tabulation performed at step 44. The results displayed at step 46 may show only the information provided by the current users, or the information provided by the current user as well as relevant baseline information. The display provided at step 46 may also include solicitations for use of the site to deliver relevant functionality, and offer opportunities for signing-up for access to the full capabilities of the site.

The best practices survey provided by the software component 22 of FIG. 2 is provided by the Web site for the purpose of motivating a site visitor to use the features of the Web site. For example, the software component 22 of the disclosed system could output information and/or questions designed to determine how the Web site could provide an advantageous service to the current user. The operation of the disclosed system through the software component 22 may further be designed to guide a user to one or more predetermined services provided by the Web site. In addition to the baseline information described above, the disclosed Web site may also generate a database consisting of information provided by various visitors to the site through the software component 22 over time for the purpose of determining customer needs with regard to prospective automated services or features that could be offered by the Web site. Since the information stored in such a database is specific to and known only to a particular instance of the disclosed Web site, it may be treated as a proprietary asset by a service provider/owner of the Web site.

Further in connection with the software component 22 of FIG. 2, the disclosed system may operate to allow a visitor to register with the system by entering an email address and/or other information. In return for such registration, the disclosed system may provide data to the visitor that may be relevant his or her needs, such as the results of analysis performed on data collected through the best practices survey, and/or best practices information from some other source.

Information obtained through the on-line best practices survey provided by software component 22 may further be used by a provider of the Web site to provide personalized notifications including e-mail 24, for example to be forwarded to specific customers through a customer/student relationship software application 38. Responses to such notification may further support the development of marketing information by a service provider.

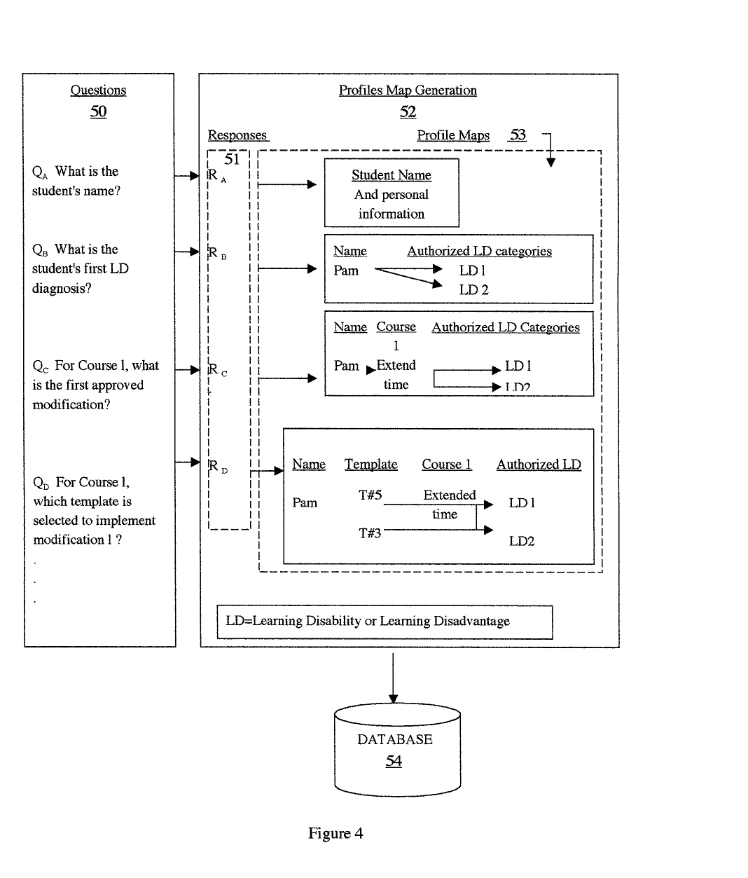

The disclosed system further enables a first time user 18 to skip the best practices survey generated by the software component 22, and start directly by accessing the software component 26, through which the first time user 18 completes an on-line teacher and/or student profile provided by the disclosed system. Further with regard to software component 26, based on the student and teacher profile information provided therein, the disclosed system displays a profile map, for example through a graphical user interface (GUI). An example of steps performed to generate such a profile map is diagrammatically represented in FIG. 4.

As shown in FIG. 4, as each of the questions 50 are answered, the relevant personal and learning disability related diagnosis and prescribed interventions, modifications, and other supports are presented in one of the exposure maps 53. In particular, as a first question Q^{a} is answered with a first response R^{a}, a corresponding one of the exposure maps 53 is presented to the user. In the case where the first question is an inquiry as to the name of the student-user, and the response is John, then the profile map generated would illustrate that the student-user A is John. Each subsequent profile map would add visual components reflecting subsequent answers. For example, if the next questions asked what disability the student user was diagnosed with, and the corresponding answer indicated Dyslexia, then the disclosed system would generate a profile map showing both the student user's name and the diagnosis of dyslexia. This process continues until all of the questions 50 are answered, thus progressively building a graphical representation for all the responses provided to each of the questions 50.

The information obtained through the responses to the questions 50 may further be stored in a database 54 for subsequent personalization of features or service of the disclosed system, matching to services and for other analytical purposes. The profile maps 53 provided in the process illustrated in FIG. 4 are designed to motivate the user to provide data into the customer profile through the software component 26 of FIG. 2, and the data presented in the profile maps 53 is provided in a way that predicts the display format and features of various components provided by the disclosed system.

Through software component 25 in FIG. 2, designated teacher-users, whether a teacher-user may designate a teacher, tutor, resource room service provider, or administrator, may develop or upload through a screen entry requesting teacher-profile specific or student-profile specific data as “student name”, “student identification number”, “student grade”, “student year of graduation”, “student school”, “student account number”, “student's school address”, “Student's school phone number”, “student's liaison, title and phone number”, “vice principal of special education's name, title, and phone number” , “start date”, “end date”, “parent's name, address, and phone number”, “individual educational plan (“IEP”) status”, “date of last update of IEP”, “student's schedule”, “approved accommodations, modifications, and resources by course”, “enrolled courses”, “disabilities profile”, “recommended teaching strategies”, recommended resources”, “professional articles”. User profile 26 data is stored in a user profile database 24 and pulled into software components 26, 28, 30, 32, 34, and 36.

With respect to a returning user 20 as shown in FIG. 2, a variety of entry points to the disclosed system are provided. For example, the entry of the returning user 20 to the disclosed system at any point is controlled by the contents of the user's security profile, as entered at step 26. The security profile of the user may limit entry and access to the disclosed system based on multiple user provided variables, including name, function, location, unit, time, currency, institution, and other alternatives. The authorization levels stored in a user profile may reflect authorization levels for a user provided by the user's organization, and/or authorization levels provided by the service provider. In this way, the user's organization can control which persons are authorized to perform which actions through the system, and the service provider can control how the system provides information and/or service to each individual user of the system.

The returning user 20 in FIG. 2 may select from a number of alternative entry points or interfaces of the disclosed system, including interfaces to software components for obtaining class schedules 28, configuring homework assignments 30, enabling test preparation and taking 32, enabling reading and related output 34, and enabling project management and related output 36. Individually and collectively the five components 26, 28, 30, 32, 34, and 36 provide a powerful and flexible platform which supports an end-to-end, real-time, Internet-based homework management capability for the designated marketplace. In the illustrative embodiment, the five software components 26, 28, 30, 32, 34, and 36 are implemented using inter-operating, application layer software components associated with a Web site.

Through the five software components 26, 28, 30, 32, 34, and 36, the disclosed system integrates complete personalized services and solutions that provide significant cost, time and intervention learning advantages by having complex specialized needs met at one place. Services provided by the disclosed system are designed to support the user's needs for educational interventions and modifications created by learning disabilities or disadvantages.

Further in the disclosed system, Modifications 41 and Resources 42 in FIG. 2 are projected, matched, and pulled from the Student Relationship Software application and database and used to populate the five software components 26, 28, 30, 32,34, and 36.

The returning user 20 in FIG. 2 may be based in any school in the country and consequently any state laws and federal laws can provide the governance over the system. For illustrative purposes, the returning user 20 will be considered to be a student-user based in the Lexington Public Schools, in the Commonwealth of Massachusetts, in the United States of America. Further, for illustrative purposes, the returning user 20 may access the site, for example, in order to respond to a teacher's request to the Level I class for completion of an Algebra I home work assignment of 10 problems on page 100 for delivery in class the following day, Oct. 2, 2001. The disclosed system may be used to break down and assist with the assigned homework using the following inquiries: (i) what modifications or interventions does the student-user's IEP or other source document apply to this assignment? (ii) how does the teacher-user, for example, communicate with the student-user around this assignment? (iii) what tools are accessible to the teacher- and student-users? (iv) what methods are applied to the production, tracking and delivery of the assignment? (v) what methods are applied to develop organization and time management skills? and (vi) what process is provided to measure and report successes and failures? The disclosed system moves step-by-step through this entire process, providing the necessary management and organizational support technology and knowledge base for users to effectively manage independent academic assignments and access the specific technology and tools that support implementation under best practices standards. Those guided in the art will recognize that this sample is provided for purposes of describing the operation of an embodiment of the disclosed system under one simple set of circumstances. Accordingly, it will be understood that the disclosed system is not limited in application to this particular problem, but may be generally applied to a variety of problems of varying complexity in this area.

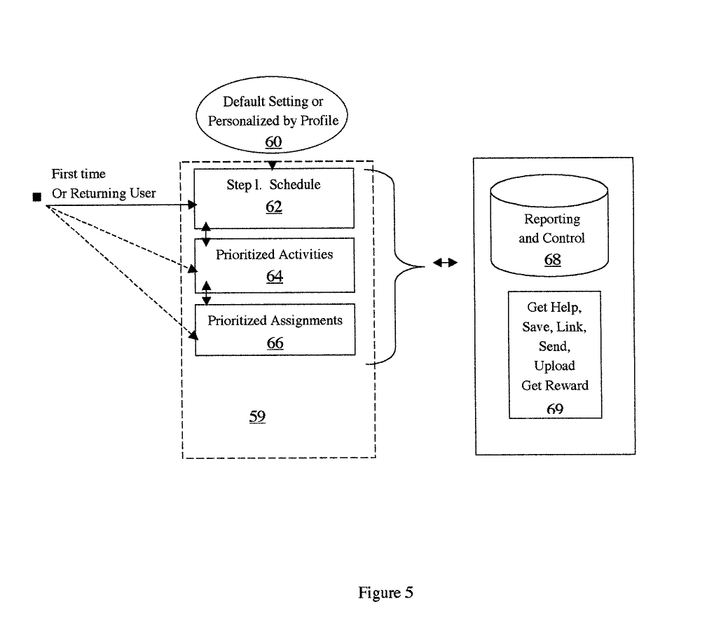

In the case where the returning student-user 20 in FIG. 2 is completing the above described independent Algebra I assignment, he or she enters through security and personalization applications using a password and is welcomed to the personalized “home” page which may feature, for example, the student-user's personal real-time daily or weekly schedule in FIG. 5.

FIG. 5 illustrates the disclosed process for quickly and effectively focusing, tracking, and structuring a schedule 62 relative to managing academic activities 64 and responsibilities under projected priorities for assignments 66 utilizing user specific data.

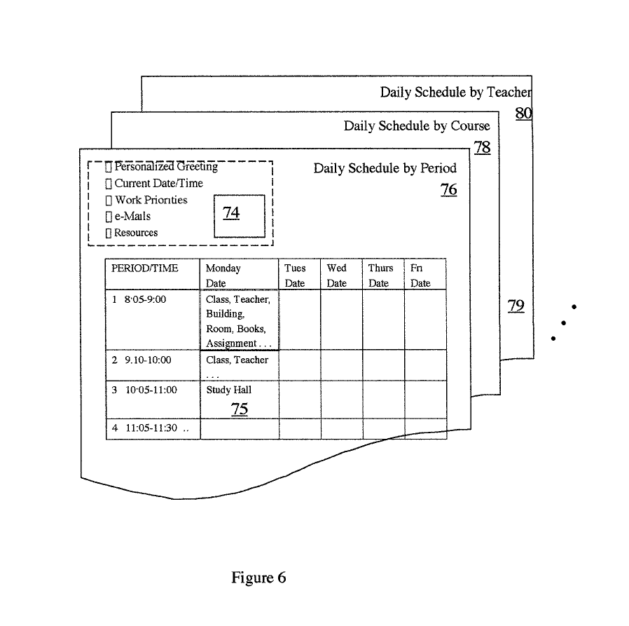

Further, FIG. 6 shows an illustrative display appearance for the student-user's schedule 62 in FIG. 5 for presenting, predicting, focusing, and tracking outcomes of independent work assignments for the management of homework or other independent academic assignments for the target market's education characteristics. The student-user, accessing the schedule on Oct 1, utilizes this schedule 76 to identify the time and period of the Algebra I class the following day, Oct. 2. A reminder of the new assignment and other assignments due the following day in order of priority 74 focuses the student-user and the assignment is slotted by the system into a homework time, either a study hall 75 or after school time as determined by the student-user profile map.

In the case where the returning student-user 20 in FIG. 2 is completing an Algebra I homework assignment, he or she may begin traversing the disclosed Web site to determine today's assignment by selecting the homework assignment record software component 30 shown in FIG. 2 as an entry point. As further described below, software component 30 may be used for: (i) obtaining and organizing assignments relative to a returning user's personalized learning characteristics, (ii) applying interventions or modifications to a production environment, (iii) delivering completed assignments, (iv) obtaining various forms of support in achieving the assignments, or (v) recording completion of assignments within the student relationship management software application 38 in FIG. 2.

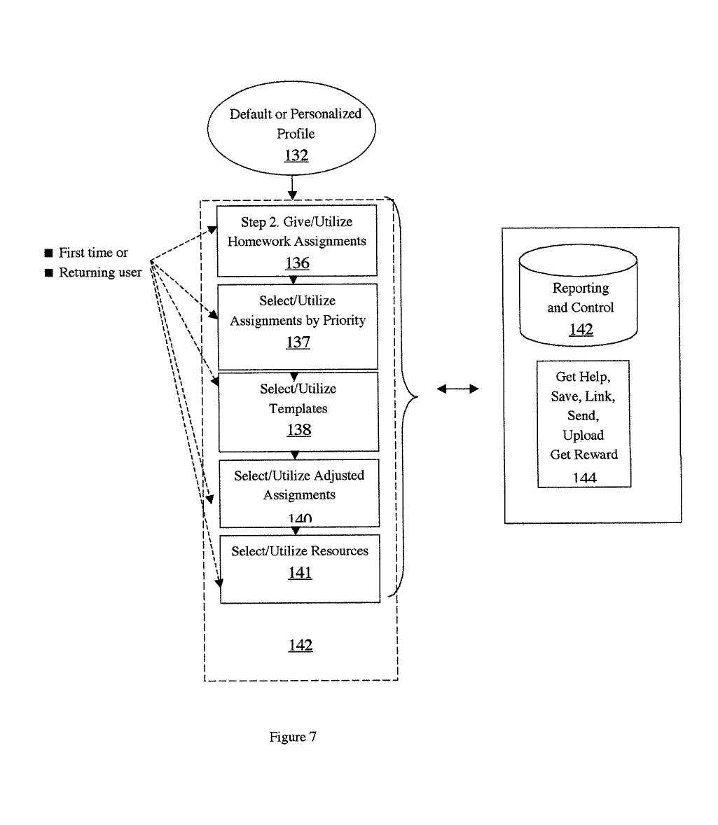

The process for obtaining homework assignments performed by the software component 30 shown in FIG. 2 is further illustrated in FIG. 7. As shown in FIG. 7, a cluster of software components 142 is provided by the disclosed system to the student-user in order to provide a homework assignment record consistent with input information including the user's profile map 26 in FIG. 2 relative to modifications, interventions, or other resources.

The student-user may select from the inter-operating homework assignment record software components 142 in FIG. 7 provided by the disclosed system, beginning with a daily or weekly assignments record by variables such as by class 136 which are then prioritized by class 137. The student-user may utilize the disclosed system first to ask “what is my assignment in Algebra I today?” Such an assignment record may be generated by the teacher-user through an upload directly from other external application or entered directly into the system. Then, templates 138 imbedded in the disclosed system are identified by assignment and utilized to: (i) interpret that assignment, (ii) adjust, and/or modify it consistent with the student-user profile map, (iii) produce the adjusted assignment for display 140, and then, (iv) allocate resources 141 identified by the student-user profile map, by variables such as course, class or subject and made accessible on-line. For the Algebra I assignment, the teacher may enter the non-modified assignment given all students directly into the system using a pre-selected template 138 chosen by the teacher-user when setting up the student on the system initially, or the teacher-user may select an alternative template 138 available. The template creates the adjusted assignment, in this instance, difficulty in output production from fine motor skills problems results in a standard reduction in output production of 50%, with every other problem assigned via the template. The student-user's adjusted assignment is uploaded into the assignment record software component in FIG. 7, recording the chapter, pages, problems, instructions, and identifying selected resources 141 made available, in addition to adding the assignment to the due date schedule. The student produces the homework off-line accessing a range of resources 141 allocated in the student-user profile map including an on-line calculator and access to the problem solutions. If the student-user encounters problems, a tutor e-mail 144 may be selected which, depending on pre-determined resources, may be an on-line tutorial or access in pre-defined times to tutoring. When completed, the notifies the teacher via e-mail 144. Assignments and applied modifications may be tracked, reported, and stored by a reporting and control database 142. On-line tools 144, accessible to the student-user include, for example, tutoring, messaging, and rewards provided upon sending e-mail notice of completion of the assigned work. Personalized reporting, available to the student-user, tracks progress in multiple way, for example, the percentage of assignments completed on time, the average past due days on assignments, or the percentage of times selected resources as utilized for each assignment type. This provides the student-user with an understanding of his/her utilization of available services and the related success or failure, enabling the student to act as a self-advocate relative to his/her needs. On a consolidated basis and utilizing a privacy application, this system further supports efficiency and effectiveness by collectively analyzing data in database 39 in FIG. 2. Finally, it provides for the assigning of costs to each intervention, modification and resource so that individual and aggregate user costs can be determined and patterns analyzed with the goal of measuring the cost of the system and student's performance in applying the provided resources.

Because the site provides end to end support, in that a student-user can go from obtaining an homework assignment to turning it in, correcting it and obtaining reporting on progress, the disclosed system enables a service provider to present consistent structure for educational modifications to a given student-user throughout the entire process. This consistency of application, integrated with the services available, eliminates the user's need to access other sites for assistance or information. Moreover, the interventions are applied privately.

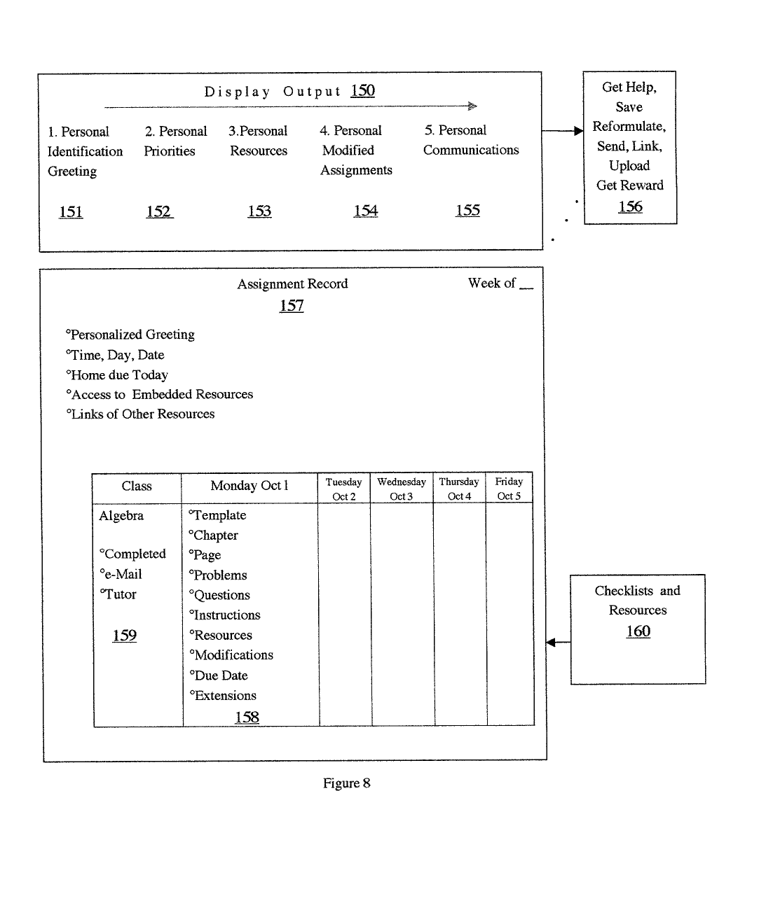

FIG. 8 further illustrates the personalized output 150 of the assignment record offerings described in FIG. 7. Including personalized identification and greeting 151, priorities 152, resources 153, interventions and/or modifications 154, and communications 155 which displays 157 may include by class, for example, the assignment by book chapter, page, problems, instructions, resources, and due date. A similar structure for past due work accessible to both student and teacher-users enables negotiations and monitoring of progress. Finally, checklists 160 of available modifications and/or interventions and of resources by course and by teacher for the student-user can be viewed by the student-user for selection in addition to or in replacement of teacher-user selections.

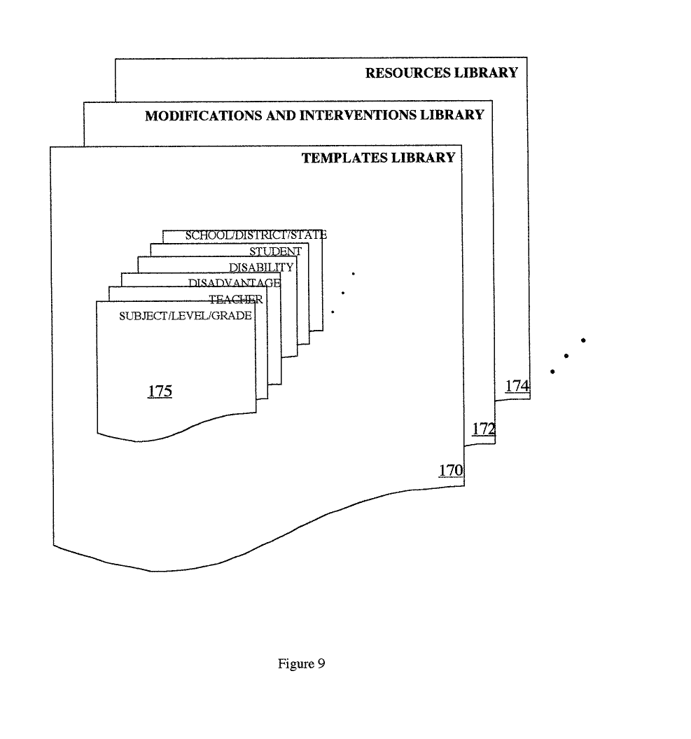

FIG. 9 further describes the templates, modifications and/or interventions, and resources supplied by the disclosed system for selection by teacher-users relative to student-user profile maps such that if a student profile includes fine motor skills problems, the system selects from the libraries a series of suggested resources to the teacher-user. These libraries are further classified by multiple variables including: (i) subject/level/grade, (ii) teacher, (iii) disability or disadvantage, (iv) student, and (v) school, school district, state, and country.

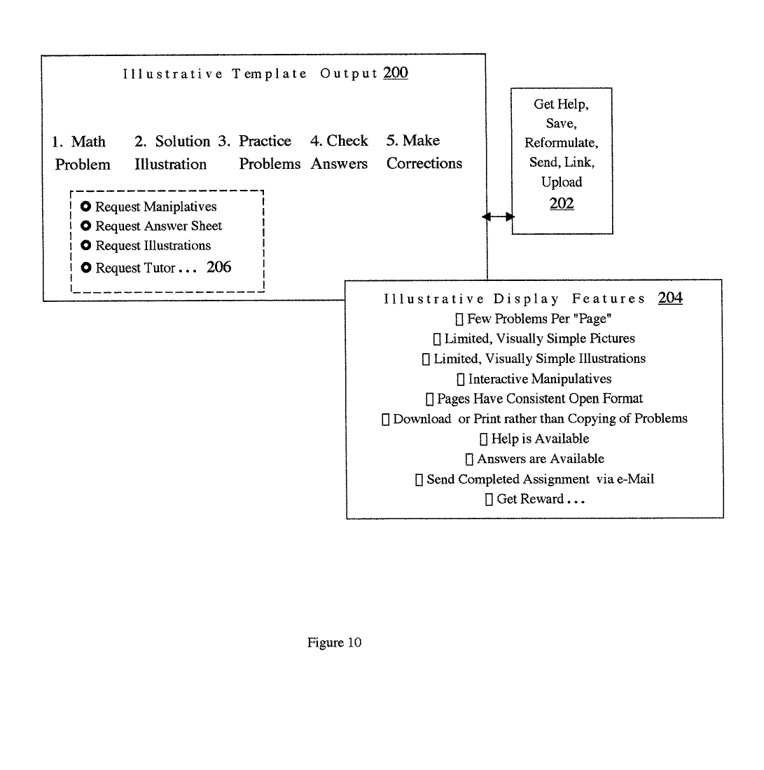

FIG. 10 operates to display the output of a template 170 described in FIG. 9 that may be utilized by the student-user to successfully organize and produce the Algebra I assignment. If the disabilities called for by the student-user profile required, for example, further modifications for fine motor skills problems including either on-line production of work or the availability of a printed worksheet to reduce, for example, copying time and errors or to allow focus on results, the resulting display 200 may, for example, include, in addition to the reduced number of problems: (i) the math problems assigned available either on-line or printable, for example, (ii) solution illustrations, (iii) practice problems, (iv) answer checking, and(v) corrections. Additional approved modifications may be requested 206 as needed. If the student-user also demonstrated visual perceptual problems, the output display features 204 of the template illustration may additionally include, for example: (i) fewer problems per page to give an open appearance, (ii) omission of pictures and use of simple illustrations to reduce visual confusion, (iv) visually consistent formats across all outputs or (v) solutions availability in order to provide immediate feed back.

Having obtained the modified homework assignment and selected resources for the task, the student-user may then employ the software components in FIG. 8 to: produce the work on (or off-line), deliver the work on (or off-line) 159, provide notification via e-mail to the system of achievement 159 upon which the disclosed system calculates and stores or delivers reward points or other rewards based on the student-users profile.

The student-user, having now completed the math assignment, may again traverse the disclosed Web site returning to schedule software component 28 in FIG. 2 to determine his/her a further assignment in order of priority and selects, for example, preparation for an English test scheduled for Oct 2 in period 2 with Mrs. White on adjectives, chapter 3, pages 74-79 in “English Writing”.

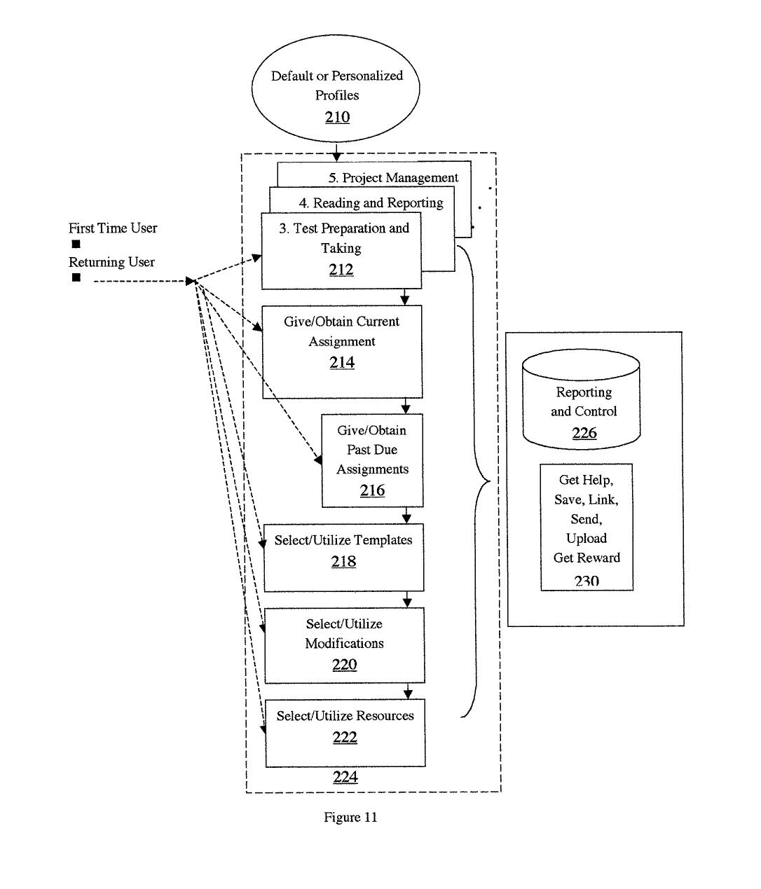

By traversing to test preparation and selecting testing software component 36 in FIG. 2, the student-user then encountered the plurality of inter-locking testing software components in FIG. 11 that may be selected and utilized to effectively organize and prepare for the current test assignment 212, review past due assignments 216 that relate to the testing material, and then utilize test preparation templates 218 and/or modifications 220 or resources 222 to prepare for the test on Oct 2. The templates 218, modifications 220, and resources 222, may include a specifically designed computer assisted instruction and computer assisted modifications including, for example: (i) practice tests, (ii) on-line tutoring, (iii) videos, or (iii)interactive exercises tailored to the student-users learning characteristics as determined in the profile map.

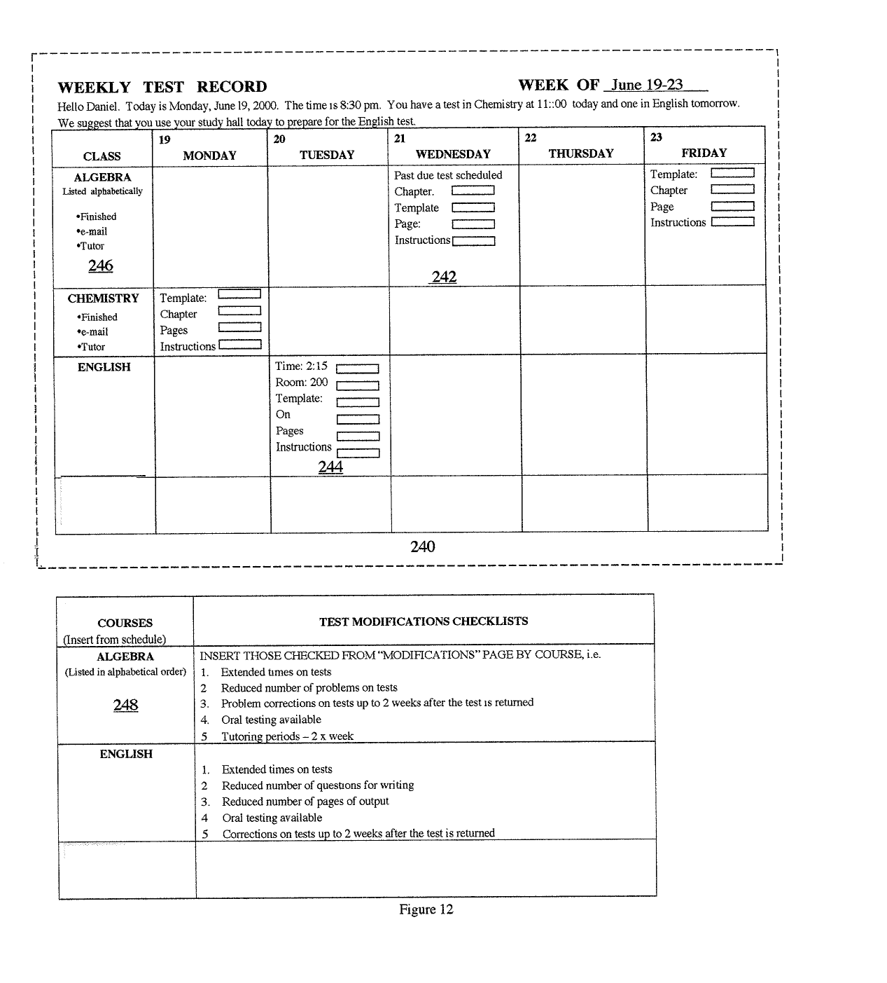

The software components utilized in FIG. 11 then operate to display the results of the selections in FIG. 12. The resulting displays may, for example, include: (i) a calendar of test schedules 240, (ii) a calendar of past due test schedules 242, (iii) referenced templates, chapters, pages, and/or problems 244, (iv) access to resources 246, and (v) access to modifications 248. The display output provided in FIG. 12 displays the concise methodology for supporting organization and time management skill deficits relative to, for example, testing or project management, or reading and reporting and for developing these skills applied by the disclosed system. For the student-user, the test schedule 240 and past-due test schedule 242 inform of the English test on Oct 2 at 2:15 PM in room 200 with Mrs. White. Further, the template(s) 244 modify the chapter, pages and problems for the student-user's learning characteristics consistent with their student-user profile map by, for example, selecting and/or reducing the testing material.

During the course of test preparation, the student accesses designated resources 246 such as online practice tests and communicates 250 the completion of test preparation, the need for a tutor, or other e-mail communications which communications then form the basis of analysis, a rewards system, and feed back through the student relationship management database 38 in FIG. 2 to the student and teacher-user as well as, on a scrubbed basis assuring privacy, to the administration for compliance measurement and other analytical purposes including assessment of associated costs of services delivered.

The student-user has now utilized a sequence of computer assisted instruction, time management, and modifications management inter-locking software capabilities depicted in FIG. 2 to achieve success relative to specific learning characteristics and to communicate this success (or failure). The student-user, applying the methodology disclosed in the system for supporting organization and time management skill deficits relative to, for example, organizing schedules, organizing homework assignments, testing or project management, or reading and reporting, and for developing these skills, is prepared to: (i) locate, understand and perform each independent assignment, (ii) locate each class scheduled relative to assigned rooms, times and work assignments, (iii) communicate and collaborate with teachers and other service providers, (iv) track work production at various stages of completion, (v) access tools to assist in the production and organization of work assignments, (vi) receive formats for work production, (vii) participate in a rewards system, and (viii) analyze performance.

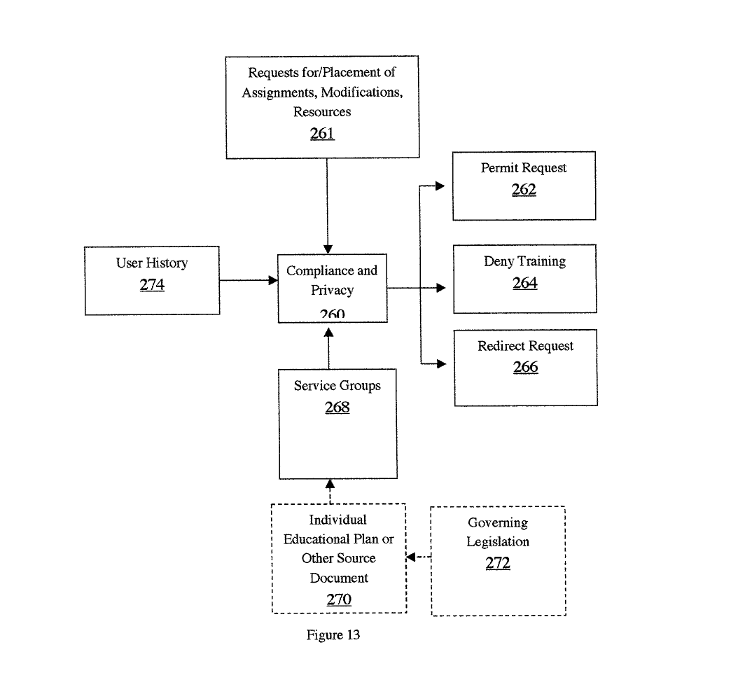

The compliance and privacy software functionality 258 of the disclosed system is depicted in FIG. 13. On behalf of the service provider on whose web server system 14 (FIG. 1) the disclosed system resides, the disclosed system establishes service group profiles 268. The service group profiles include, for illustrative purposes, multiple sources of student-user controls. These are: (i) the student-user profile map 268 completed through software component 26 (FIG. 2); (ii) the student-user personalization 268 completed through software component 26 (FIG. 2); and (iii) the user history 274 completed through database 39 (FIG. 2). This compliance functionality 258 is informed by external sources uploaded into the disclosed system from documents such as Individual Educational Plans and governing legislation and/or policies and procedures of schools, districts, states, or federal governments.

The disclosed compliance functionality 258 system monitors, governs, and reports on every aspect of the system on a integrated and real time basis. In response to operation of the disclosed compliance functionality 258, the disclosed system may alternatively permit a request at 262, deny the request at 264, or redirect the request at 266 and indicate the user's deficiency and corrective actions.

With respect to the above-described example of a student-user activities, the homework management process has now come full circle, and the desired academic results have been achieved. Empowered by flexible and integrated tools and technology delivered through the disclosed system, the student-user has utilized this five-step process defined by the software components 26,28,30,32,34, and 36 shown in FIG. 2 in order to: (i) to take ownership of the homework process through the support provided through the automated but natural progression of the sequence that over time may be internalized; (ii) to focus their efforts on understanding and learning rather than on output as modification, interventions or resources are automatically brought to bear that compensate for identified learning characteristics; (iii) to make learning interactive, collaborative, and multi-dimensional through modifications and methods which they use to explore and understand assignments; and (iv) to gain efficiency in terms of time and costs not only for student-users, but also teacher-users and administrations adopting the disclosed system; (v) to monitor the system's effectiveness and results in aggregate or at the individual user level; with the goal (vi) of developing increasing organization and time management skills.

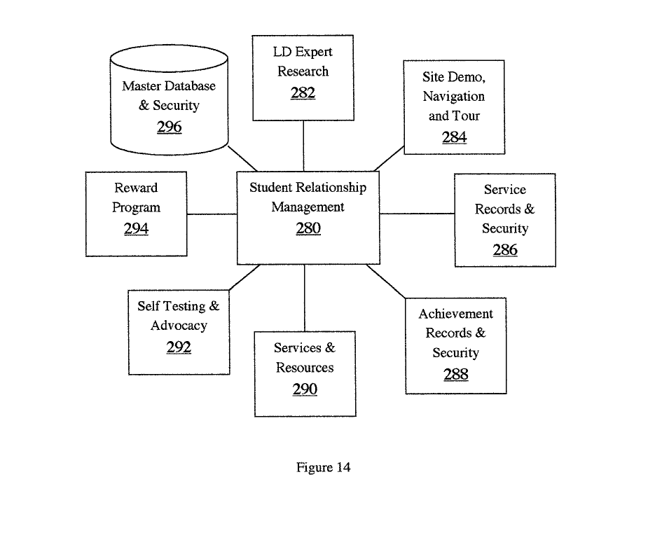

Supporting the homework management system herein disclosed is a student relationship management (SRM) software application illustrated in FIG. 14. A cluster of services is available to the service provider through business rules stored in the master student relationship database 296 in order to market the services, measure use of the services, support customers of the service, and predict needs. These features include for illustrative purposes: online demo of the services, site navigation and tour 284; on line service records under security 286; online achievement records 288; on line services and resources 290; on-line self testing and advocacy 292; and online rewards programs 294.

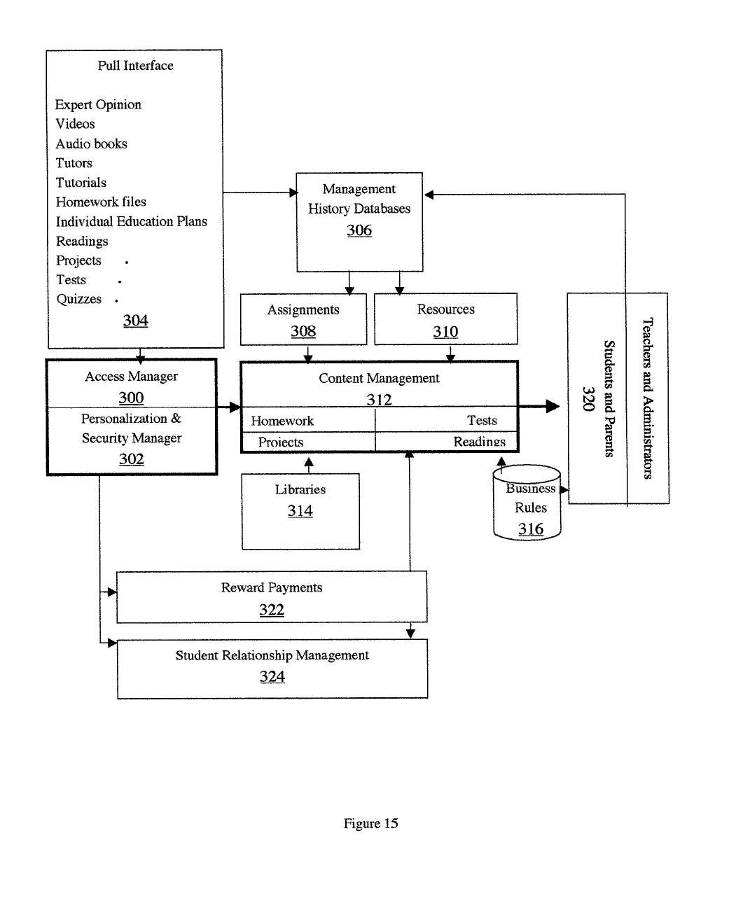

The inter-relationships of various applications software components employed in an illustrative embodiment of the disclosed system are shown in FIG. 15. These components may be programmed in, for example, Java, JavaScript, Active Server Pages, Web dB, and/or PL/SQL programming languages, and may be serviced through databases such as Oracle 8i or IBM's WebSphere. As shown in FIG. 15, an access management application 300 governs a customer entry and personalization application 302. A pull interface application 304 pulls data from various external sources into a content management application 312 through a management history database 306 and assignments 308 and resources 310 applications. In addition, the content management application 312 is fed data from the templates, modification/interventions, and/or resources libraries application 314. As a result, and consistent with the business rules database 316, the student-users and teacher-users receive, produce, and process output 370. Homework history 306 collects data on all homework from output 370 into a database such as Oracle 8i. A payment rewards application 322 accepts rewards data from homework output functionality 370 on a personalized basis. Finally, a student relationship management application 324 also interfaces to the system through the personalization functionality 302 and the homework output functionality 370.

The foregoing example of a student-user solving a learning problem with the disclosed system, in which the very simple decision of completing a single Algebra I homework assignment, is intended to suggest the many users of the disclosed invention that in reality are wide ranging and complex. The many student-users and teacher-users within the target market for the disclosed system, that are involved in education and learning, will utilize this disclosed system in strategic and tactical ways as a result of its great versatility. Likewise, service providers offering the diverse services of the disclosed system to the target customer group may offer the services on a self-help basis and/or at the same time have its teacher-users support the delivery of services to students utilizing the efficiency and effectiveness that the system provides.

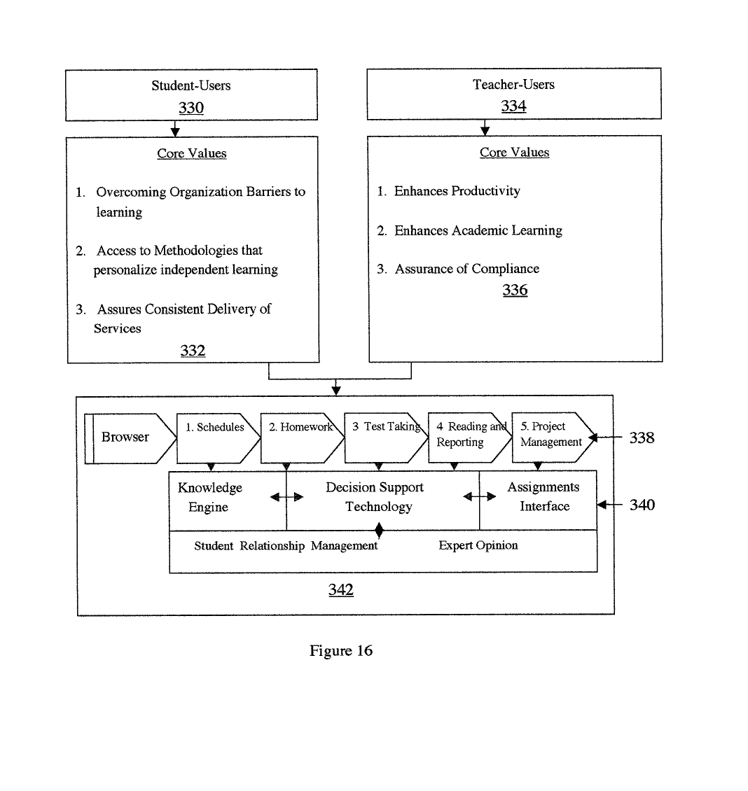

As shown in FIG. 16, for teacher-users of the disclosed invention may increase their productivity through the following features, for example: (i) usage of profile maps to match and assign modifications, interventions, and resources relative to individual users or classes of users; (ii) usage of templates to deliver and manage modifications, interventions and resources on a personalized level; (iii) usage of databases to measure and analyze and report performance at all levels while assuring privacy; and (iv) usage of new automated methods of collaboration communication to support student learning. In addition, the disclosed invention supports learning any time and any where; provides structures to allow effective learning; and provides for accurate implementation of educational plans which create the basis for improved audits.

When used by student-users 330 in FIG. 16, the disclosed system delivers core values 332 including: (i) methods and systems to help bypass, work around, and compensate for organization barriers to learning, thus allowing success despite disabilities or disadvantages; (ii) access to methodologies that personalize independent learning; and (iii) assurance of consistent delivery of mandated services. These result in learning and emotional enhancements to the users that do not presently exist. When used by teacher-users 334 in FIG. 16, the disclosed system deliver core values 334 including: (i) enhanced productivity, (ii) enhanced academic learning, and (iii) the assurance of compliance with mandated service delivery. For both user groups, by accessing an integrated solution to meet specialized complex needs, relationships are fostered within centered communities with each service provider and between service providers. Together, through the summary process 342 depicted in FIG. 16, teacher-users and student-users relate in new ways that mutually support educational objectives and produce new efficiencies in service delivery, thus helping assure its continuing and improving delivery.

Those skilled in the art should readily appreciate that programs defining the functions of the disclosed system and method for determining deadlock free routes can be implemented in software and delivered to a system for execution in many forms; including, but not limited to: (a) information permanently stored on non-writable storage media (e.g., read only memory devices within a computer such as ROM or CD-ROM disks readable by a computer I/O attachment); (b) information alterably stored on writable storage media (e.g. floppy disks and hard drives); or (c) information conveyed to a computer through communication media for example, using baseband signaling or broadband signaling techniques, including carrier wave signaling techniques, such as over computer or telephone networks via a modem. In addition, while the illustrative embodiments may be implemented in computer software, the functions within the illustrative embodiments may alternatively be embodied in part or in whole using hardware components such as Application Specific Integrated Circuits, Field Programmable Gate Arrays, or other hardware, or in some combination of hardware components and software components.

While the invention is described through the above exemplary embodiments, it will be understood by those of ordinary skill in the art that modification to and variations of the illustrated embodiments may be made without departing from the invention concepts herein disclosed. Accordingly, the invention should not be viewed as limited except by the scope and spirit of the appended claims.

### Glossary Of Special Education Terms

Accommodations: Refers to techniques and materials used in education that do not change the basic cirriculum, but do make learning easier for the learning disabled.

Assistive Technology (“AT”): Refers to any type of equipment that is used to bypass or work around a specific learning deficit, which can be as simple as utilizing a pencil grip to outlining software.

Dysarthria: Refers to disorder of fine motor muscles involved in speech.

Dyscalculia: Refers to problems with basic math skills.

Dysgraphia: Refers to difficulty writing legibly or at normal speed.

Dysgraxia: Refers to difficulty performing and sequencing fine motor movement.

Dyslexia: Refers to disorder in oral and or written language.

Individual Educational Plan (“IEP”): Refers to a written plan developed to meet the unique needs of a disabled student who requires special education services to benefits from general education.

Individuals With Disabilities Education Act (IDEA): An act passed in 1975 by the federal government providing “free and appropriate education” to all students with disabilities and amended in May 1997.

Learning Disabilities: Refers to individuals who have a disorder in one or more of the basic neuro-psychological processes involved in understanding or in using language, spoken or written, which disorder may manifest itself in imperfect ability to listen, think, speak, read, write, spell, or do mathematical calculations. These conditions include: perceptual disabilities, brain injury, dyslexia, and developmental aphasia. Learning disabilities do not include learning problems which are primarily the results of visual, hearing, or motor disabilities, of mental retardation, emotional disturbance, or disadvantage.

Special Education: Refers to specifically designed instruction to meet the unique needs of eligible students whose educational needs cannot otherwise be met by modifications to general education.

Visual Processing: Refers to the ability to interpret visual information when the person has normal eyesight.

What is claimed is:

1. A method, operable in a server system, for tracking at least one homework assignment, wherein said homework assignment reflects accommodations for said user disabilities, comprising:
obtaining said at least one homework assignment;
obtaining said at least one template with said homework accommodations for said user;
obtaining said at least one modification with said homework accommodations for said user;
obtaining said at least one resource with said homework accommodation for said user;
displaying said at least one homework assignment;
prioritizing at least one homework assignment of a user;
storing said at least one homework assignment of a user;
monitoring at least one homework assignment of a user;
reporting at least one homework assignment of a user;
preventing at least one predetermined activity of said user in the event that said user activity conflicts with said one homework assignment; and
rewarding at least one homework assignment of a user.

2. A method of claim 1, wherein said one homework assignment comprises obtaining a test assignment, reformulating said test assignment consistent with said user profile associated with said disability.

3. A method of claim 2, wherein said one test assignment, and said reformulation, comprises obtaining at least one template utilized to employ at least one accommodation associated with said disability.

4. A method of claim 3, wherein said one test assignment further comprises obtaining at least one modification of said one test assignment.

5. A method of claim 3, wherein said one test assignment further comprises obtaining at least one resource for said one test assignment.

6. A method of claim 3, wherein said one test assignment further comprises making at least one communication reporting one test assignment.

7. A method of claim 1, wherein said one homework assignment comprises obtaining a reading assignment, reformulating said reading assignment consistent with said user profile associated with said at least one disability.

8. A method of claim 7, wherein said one reading assignment, and said reformulation, comprises obtaining at least one template utilized to employ at least one accommodation associated with said at least one disability.

9. A method of claim 7, wherein said one reading assignment further comprises obtaining at least one modification of said one reading assignment.

10. A method of claim 7, wherein said one reading assignment further comprises obtaining at least one resource for said one reading assignment.

11. A method of claim 7, wherein said one reading assignment further comprises making at least one communication reporting one reading assignment.

12. A method of claim 1, wherein said one homework assignment comprises obtaining a project assignment, reformulating said reading assignment consistent with said user profile associated with said at least one disability.

13. A method of claim 12, wherein said one project assignment, and said reformulation, comprises obtaining at least one template utilized to employ at least one accommodation associated with said at least one disability.

14.A method of claim 12, wherein said one project assignment further comprises obtaining at least one modification of said one project assignment.

15.A method of claim 12, wherein said one project assignment further comprises obtaining at least one resource for said one project assignment.

16.A method of claim 12, wherein said one project assignment further comprises making at least one communication reporting one project assignment.

17.A method of claim 12, wherein said one project assignment further comprises making at least one display of one project assignment.

18.A system for providing homework organization and time management services to accommodate learning disabilities via a server system, wherein said server system includes at least one processor, a program storage memory, and program code stored within said program storage memory, wherein said program code comprises:
an instructional engine, wherein said instruction engine includes software components operable to obtain learning disabilities knowledge, formulate applicable learning interventions, modifications, and resources, and to provide online training with regard to methods and structures of support to achieve homework success for users with learning disabilities and who are teenagers;
decision support technology, wherein said decision support technology includes software components operable to match appropriate learning intervention strategies based on disabilities relative to homework production assignments such as testing, reading and associated output, projects and associated output, and calculating and associated output, and subsequently to determine at least one intervention strategy, to apply at least one intervention strategy to at least one learning disability, and to communicate the at least one match to the user; and
an assignment interface, wherein said interface includes software components operable to implement said at least one intervention strategy for the user and to report said implementation of said at least one intervention.

19.A server system connectable to a computer network, operable to provide organization and time management intervention services related to learning disabilities, comprising:
program code for obtaining a student user's school schedule; and
program code for creating said student user's and a teacher user's profile; and
program code for providing learning templates, modifications, interventions, and resources applicable to said student user's and said teacher said user's profiles; and
program code for determining appropriate said student user's said school schedule utilizing said templates, modifications, interventions, and resources to translate standard homework assignments into modified homework assignments relative to said student user's profile; and
program code for providing, responsive to said modified homework assignments, at least one display object education intervention relative to said student to said student user's profile.
program code for monitoring user actions with respect to activities regarding delivering homework accommodations; and
program code for providing, responsive to said monitoring of said user actions, at least one on-line student-user's profile in the event that said user actions include at least one predetermined user action, wherein said at least one on-line student-user's profile presents data regarding said education intervention related to said at least one predetermined user action.
program code for displaying a plurality of decision categories;
program code for obtaining a user selection of one of said decision categories;
program code of displaying, responsive to said selected one of said decision categories, a predetermined educational accommodation corresponding to said selected one of said decision categories; and
program code applying said corresponding analysis to user data.
program code for obtaining a plurality of user homework modifications relative to learning disabilities;
program code for aggregating said plurality of user homework modification; and
program code for passing said aggregating to a schedule, such that said homework modifications compensate for said learning disabilities.

20.A server system, connectable to a computer network, operable to present a performance report regarding homework modifications usage, comprising:
obtaining an overall said homework modifications usage level associated with a user and user group;
displaying, by said user and said user group, in aggregate, said homework modifications usage level base on said overall usage;
obtaining an detailed said homework modifications usage level associated with a user and user group; and
displaying, by said user and said user group, in detail, said homework modifications usage level base on said overall usage.

21.A server system, connectable to a computer network, operable to match identified learning disabilities and needs to identified learning accommodations, comprising:
maintain a database of information regarding templates, modifications, interventions, resources, and rewards regarding said learning accommodations;
maintaining a database of information regarding said learning disabilities;
maintaining a database of secure information regarding student-user profiles regarding said learning disabilities;
identifying, within said databases, information relevant to said learning accommodations for said student-user profiles;
matching at least one said learning accommodation to a student user;
generating a message identifying said determined leaning accommodation to at least one said student user's schedule;
receiving a message identifying said determined learning accommodation was utilized by said student-user accessed using said schedule; and
matching said message identifying said determined learning accommodation was utilized by said student-user using said schedule to said rewards database.
